(19) United States
(12) Patent Application Publication
(10) Pub. No.: US 2025/0306767 A1
(43) Pub. Date: Oct. 2, 2025

(54) TECHNIQUES FOR IMPROVED DATA FOLDING IN MEMORY SYSTEMS

(71) Applicant: Micron Technology, Inc., Boise, ID (US)

(72) Inventors: Prasad Bylahalli Chandrashekara, Bangalore (IN); Jameer Mulani, Bangalore (IN); Amiya Banerjee, Bangalore (IN); Nitul Gohain, Bangalore (IN)

(21) Appl. No.: 19/088,780

(22) Filed: Mar. 24, 2025

Related U.S. Application Data
(60) Provisional application No. 63/572,064, filed on Mar. 29, 2024.

(51) Int. Cl. G06F 3/06

(52) U.S. Cl. CPC G06F 3/0613; G06F 3/0619; G06F 3/0659; G06F 3/0688

(57) ABSTRACT

Methods, systems, and devices for techniques for improved data folding are described. A memory system may perform a two-pass data transfer operation to transfer data from a source block to a destination block that includes temporarily storing the data in a buffer as part of a first pass and bypassing the buffer during a second pass. The memory system may store information associated with the first portion, such as whether an error was detected in the data, a time associated with the first portion, and a temperature of the source block. The memory system may determine whether one or more conditions associated with the information are satisfied. If the conditions are satisfied, the memory system may perform the second portion by issuing a command to transfer the data from the source block to the destination block without passing through the buffer, such as a copyback command.

### CROSS REFERENCE

The present application for patent claims priority to U.S. Patent Application No. 63/572,064 by Bylahalli Chandrashekara et al., entitled “TECHNIQUES FOR IMPROVED DATA FOLDING IN MEMORY SYSTEMS,” filed Mar. 29, 2024, which is assigned to the assignee hereof, and which is expressly incorporated by reference in its entirety herein.

### TECHNICAL FIELD

The following relates to one or more systems for memory, including techniques for improved data folding.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for improved data folding in accordance with examples as disclosed herein.

FIGS. 2A and 2B show examples of data paths that support techniques for improved data folding in accordance with examples as disclosed herein.

FIG. 3 shows an example of a process flow that supports techniques for improved data folding in accordance with examples as disclosed herein.

FIG. 4 shows a block diagram of a memory system that supports techniques for improved data folding in accordance with examples as disclosed herein.

FIG. 5 shows a flowchart illustrating a method or methods that support techniques for improved data folding in accordance with examples as disclosed herein.

### DETAILED DESCRIPTION

Some memory systems may perform a data transfer operation, such as a folding operation, to transfer data from a first block to a second block, such as a source block to a destination block. For example, a memory system may initially write data to a higher-performance source block, and may later transfer (e.g., flush) the data from the source block to a higher-density destination block. In some cases, the memory system may use two-pass programming for the data transfer operation, which may include two portions (e.g., passes) to write the data to the destination block. For each portion, some memory systems may transfer the data via a data path that includes applying one or more error control operations to the data, or temporarily storing the data at a buffer (such as an SRAM buffer), or both. However, transferring the data through such a data path multiple times may consume additional time and tie-up system resources, such as space within the buffer, which may decrease system performance, among other challenges.

As described herein, a memory system may perform a data transfer operation that includes temporarily storing the data in a buffer, such as an SRAM buffer, as part of a first portion (e.g., a first pass) of the data transfer operation and bypassing the buffer during a second portion (e.g., a second pass) of the data transfer operation. As part of the first portion, the memory system may store information associated with the first portion, such as whether an error was detected in the data, a first time associated with the first portion, and/or a first temperature of the source block at the first time. To perform the second portion, the memory system may determine whether one or more conditions (e.g., a first condition, a second condition, a third condition) or a combination thereof are satisfied. In some examples, the first condition may include determining whether the first value indicates that that an error was detected in the data. In some examples, the second condition may include determining whether a difference between the first time and a second time associated with the second portion satisfies a first threshold. In some examples, the third condition may include determining whether a difference between the first temperature and a second temperature associated with the second time satisfies a second threshold. If the conditions are satisfied (e.g., in some cases if all conditions are satisfied, in some cases if at least some of the conditions are satisfied), the memory system may perform the second portion by issuing a command to transfer the data from the source block to the destination block without passing the data through the SRAM buffer, such as a copyback command. By bypassing the SRAM buffer, the memory system may mitigate system resource use, which may improve the ability of the memory system to perform other commands (e.g., commands from the host system), and thus improve system performance, among other benefits.

In addition to applicability in memory systems as described herein, techniques for improved data folding may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing the time and complexity of performing folding operations, which may decrease processing or latency times, improve write performance, improve response times, or otherwise improve user experience, among other benefits.

In addition to applicability in memory systems as described herein, techniques for improved data folding may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing complexity and power consumption associated with performing folding operations, which may reduce the total power consumption of electronic devices, extend the life of electronic devices and thereby reduce electronic waste, among other benefits.

Features of the disclosure are illustrated and described in the context of systems, devices, and circuits. Features of the disclosure are further illustrated and described in the context of data paths, process flows, and flowcharts.

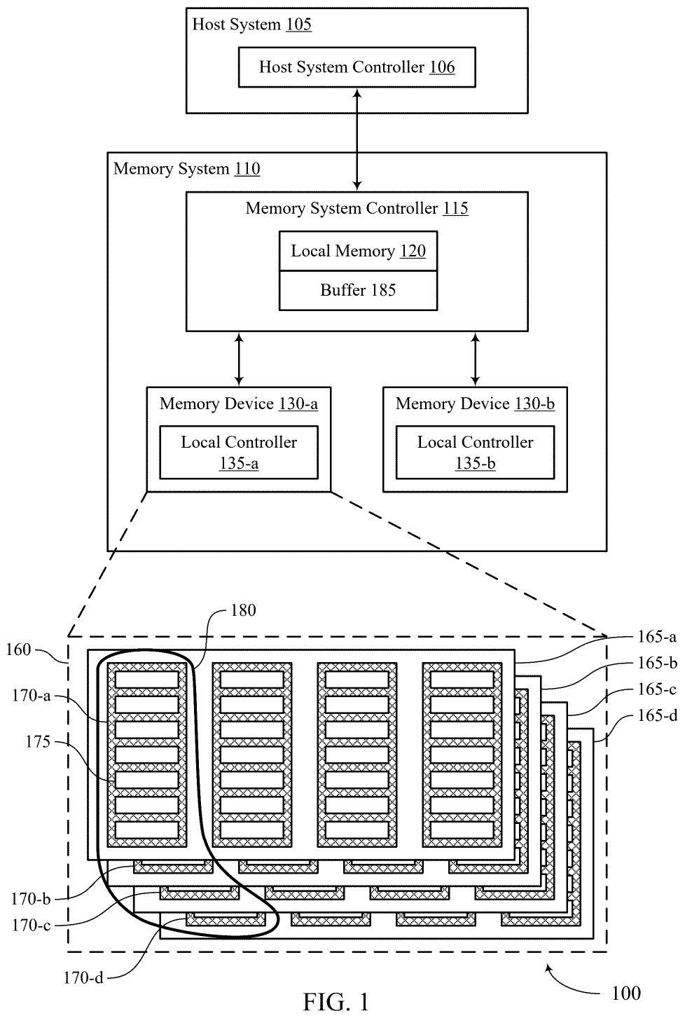

FIG. 1 shows an example of a system 100 that supports techniques for improved data folding in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support techniques for improved data folding. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, a memory system 110 may perform a two-pass data transfer operation to transfer data from a source block 170 to a destination block 170 that includes temporarily storing the data in a buffer 185 as part of a first portion (e.g., a first pass) of the data transfer operation and bypassing the buffer 185 during a second portion (e.g., a second pass) of the data transfer operation. The buffer 185 may be an example of high-performance buffer used by the memory system controller 115, such as an SRAM buffer of the local memory 120. As part of the first portion, the memory system 110 may store information associated with the first portion, such as whether an error was detected in the data, a first time associated with the first portion, and a first temperature of the source block 170 at the first time. To perform the second portion, the memory system 110 may determine whether a first condition, a second condition, a third condition, or a combination thereof are satisfied. The first condition may include determining whether the first value indicates that that an error was detected in the data. The second condition may include determining whether a difference between the first time and a second time associated with the second portion satisfies a first threshold. The third condition may include determining whether a difference between the first temperature and a second temperature associated with the second time satisfies a second threshold. If the conditions are satisfied, the memory system 110 may perform the second portion by issuing a command to transfer the data from the source block 170 to the destination block 170 without passing through the buffer 185, such as a copyback command. By bypassing the buffer 185, the memory system 110 may mitigate system resource use, which may improve the ability of the memory system 110 to perform other commands (e.g., commands from the host system), and thus improve system performance.

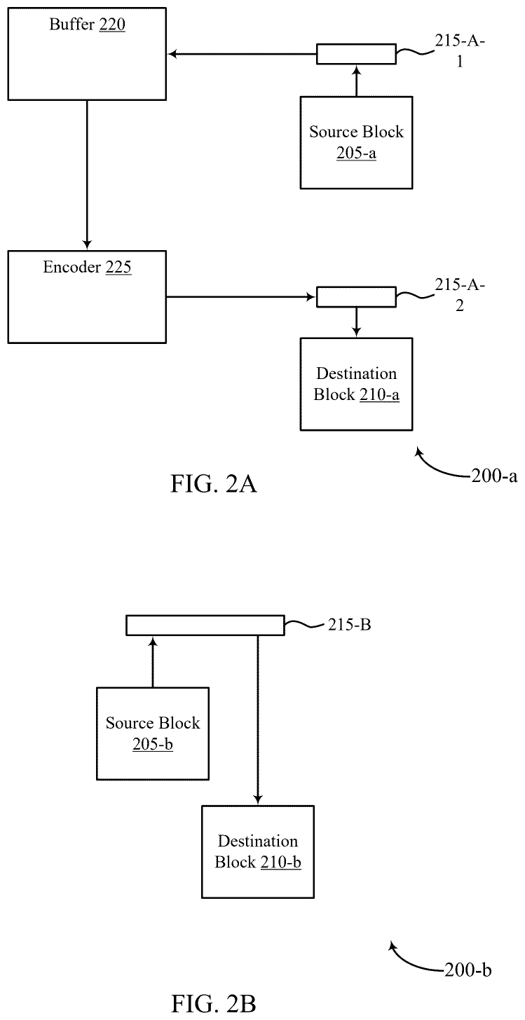

FIGS. 2A and 2B show examples of data paths 200-a and 200-b that support techniques for improved data folding in accordance with examples as disclosed herein. The data paths 200-a and 200-b may be implemented by a memory system, such as the memory system 110 as described with reference to FIG. 1. For example, the data paths 200-a and 200-b may illustrate the flow of data (e.g., user data, error correction information associated with the user data, metadata) through the memory system as part of a data transfer operation (e.g., a folding operation) to transfer data from a source block 205 to a destination block 210.

In some cases, the memory system may initially write data to a source block 205 having relatively high-performance, such as an SLC block or a TLC block. Such blocks may be associated with relatively wider read or write margins (e.g., compared with a QLC block), and thus offer improved performance. For example, the memory system may receive one or more commands from a host system (e.g., a host system 105) to write data to the memory system. The memory system may select a source block 205, and program the data to the source block 205.

As the memory system writes data to the source block 205, the source block 205 may become filled, and thus unable to service additional host write commands, which may reduce system performance. Accordingly, to improve storage efficiency, the memory system may transfer data in a source block 205 to a destination block 210 having a higher storage density, such as a QLC block. For example, the memory system may perform a folding operation (e.g., a transfer operation) using the source block 205 and the destination block 210, and may subsequently release the source block 205 (e.g., by erasing the source block 205, by marking the source block 205 as free or available) to be used for subsequent access operations. The folding operation may transfer data from the source blocks 205 (e.g., an SLC block, an MLC block, a TLC block) to the destination block 210 (e.g., a QLC block) by reading the data from the source block 205 and writing the data to the destination block 210. The memory system may read the data from the source block 205 by issuing one or more internal commands (e.g., a read command, a data transfer command), for example from a memory controller of the memory system (e.g., the memory system controller 115), to a memory device (e.g., a memory device 130, a memory die 160, a local controller 115 of the memory device 130) that includes the source block 205. The memory system may write the data to the destination block 210 by issuing one or more commands (e.g., write commands, transfer commands, program commands, copyback commands) to a memory device that includes the destination block 210. In some cases, the source block 205 and the destination block 210 may be included in a same memory device (e.g., on the same memory die). The memory system may perform the data transfer operation as part of memory management operations (e.g., wear leveling, background refresh, garbage collection, scrub, block scans, health monitoring, or others). In some cases, the memory system may perform the data transfer operation autonomously (e.g., without receiving an explicit command from a host system). Alternatively, the memory system may perform the data transfer operation as part of executing one or more commands received from a host system.

In some examples, writing the data to the destination block 210 using a multi-pass operation (e.g., a two pass programming operation). For example, if the destination block 210 is a QLC block, using a two-pass programming operation may include performing two sets of relatively small (e.g., smaller width or amplitude) programming pulses (e.g., two portions of the programming operation), instead of a single set of relatively large programming pulses, to accurately program one or more QLCs and avoid program disturb. Each programming pulse may write or program a data pattern to the destination block 210, such that after applying the second pulse (e.g., after the second pass), the data is programed to the destination block 210. Each portion of the programming operation may include moving the data through the data path 200-a or through the data path 200-b, and may be performed piecemeal. For example, the memory system may perform a first portion of the data transfer operation (e.g., a first pass), and may interrupt or delay the data transfer operation, such as to service one or more commands from a host system. At a later time (e.g., after performing the one or more commands), the memory system may resume the data transfer operation by performing the second portion (e.g., the second pass).

FIG. 2A illustrates the data path 200-a for data during a data transfer (e.g., folding) operation to transfer data from a source block 205 to a destination block 210, for example as part of a first portion of the operation. In some examples, the first portion of the operation may include issuing a read command to a memory device that includes the source block 205-a (e.g., issuing a command from a memory system controller 115 to a memory device 130). In response to the read command, the memory device may retrieve the data from the source block 205-a and temporarily store the data to a buffer 215-a−1 in communication with the source block 205-a. In some examples, the buffer 215-a−1 may be an example of volatile memory, such as a set of one or more data latches in which each data latch may be configured to store a single bit of data, and may be located in or arranged on the memory device (e.g., may be on the same memory die as the source block 205-a).

The first portion of the data transfer operation may include transferring the data from the buffer 215-a−1 to a separate buffer 220. The buffer 220 may be an example of an SRAM buffer (e.g., a buffer having one or more SRAM memory cells), such as a cache or other high-performance volatile memory, which may be located in or associated with a memory controller of the memory system (e.g., may be part of local memory 120 of a memory system controller 115). In some examples, the buffer 220 may be used as part of other operations, such as a write buffer for servicing write commands from a host system. Additionally, transferring the data from the buffer 215-a−1 to the buffer 220 may include communicating the data over a data bus between the memory device and the buffer 220, such as an Open NAND Flash Interface (ONFI) bus. Accordingly, storing the data in the buffer 220 may tie-up system resources, which may decrease memory system performance. In some cases, as part of transferring the data to the buffer 220, the memory system may pass the data through an error correction code (ECC) circuit, which may apply one or more error control operations to detect or correct (or both) one or more errors in the data. For example, the ECC circuit may be an example of a low-density parity check (LDPC) decoder. In such an example, the data may include one or more parity bits (e.g., error correction information, an embedded seed), and the ECC circuit may use the parity bits to detect or correct (or both) one or more errors. Additionally, or alternatively, the ECC circuit may use the parity bits to decode the data (e.g., decode a codeword that includes the data, modify the data using the parity bits).

The first portion of the data transfer operation may include transferring the data from the buffer 220 to a buffer 215-a−2 (e.g., via the data bus between the memory device and the buffer 220). The buffer 215-a−2 may be an example of volatile memory, such as a set of one or more data latches, and may be located in or arranged on a memory device the includes the destination block 210-a (e.g., may be on the same memory die as the source block 205-a). In some examples, the buffer 215-a−2 may be the same as the buffer 215-a−1, for example if the source block 205-a and the destination block 210-a are within the same memory device (e.g., on the same memory die). In some cases, transferring the data to the buffer 215-a−2 may include passing the data through an encoder 225. The encoder 225 may be an example of an LDPC encoder, and may apply one or more additional error control operations to the data, such as an operation to encode the data in accordance with an LDPC encoding scheme. Encoding the data may include generating one or more parity bits for the data, modifying the data (e.g., using the parity bits), or both. After the memory system has transferred and, in some cases, encoded the data, the memory system may issue a command to program the data, or a data pattern corresponding to the data, to the destination block 210-a.

In some cases, the memory system may record information (e.g., metadata) associated with the first portion of the data transfer operation. For example, the memory system may store an indication of whether an error was detected in the data, whether an error (e.g., a read error) was corrected in the data, or both (e.g., as part of applying the one or more error control operations, as part of decoding the data). In some cases, the indication of whether an error was detected in the data may include a flag, and the memory system may set the flag to a first value (e.g., true, a logical “1”) if an error was detected or corrected (or both) and may set the flag to a second value (e.g., false, a logical “0”) if the memory system did not detect or correct an error.

As part of recording the information, the memory system may store an indication of a first time at which the first portion of the data transfer operation occurred. For example, the memory system may store a value indicating a timestamp (e.g., a relative timestamp of the memory system) corresponding to the first portion of the data transfer operation, such as a timestamp that indicates the time at which data is read from the source block 205-a. Additionally, the memory system may store an indication of a first temperature associated with the first portion of the data transfer operation. For example, the memory system may store a value indicating the first temperature of the source block 205-a (e.g., a junction temperature). In some cases, the memory system may measure the first temperature at or near the first time (e.g., the first temperature may correspond to the temperature of the source block 205-a at which reading the data occurred).

The second portion of the data transfer operation (e.g., the second pass) may include programming the data to the destination block 210 (e.g., programming a data pattern corresponding to the data) a second time. In some cases, the memory system may transfer the data via the data path 200-a for the second portion of the data transfer operation. However, the data path 200-a may be associated with relatively high resource usage, such as the time to transfer the data to and from the buffer 220, which may include transferring the data over a data bus of the memory system, the time to perform the error correction operation (e.g., decoding the data, encoding the data), or both. To decrease resource usage of the data transfer operation, the memory system may bypass the buffer 220, the encoder 225, or both by using the data path 200-b for the second portion of the operation if one or more conditions are satisfied.

For example, as part of the second portion of the data transfer operation, the memory system may determine whether a first condition is satisfied, whether a second condition is satisfied, whether a third condition is satisfied, or a combination thereof. The first condition may include determining whether the memory system detected an error in the data as part of the first portion of the data transfer operation. For example, the memory system may check the value indicated whether an error was detected in the data (e.g., check the value of the flag) stored as part of the first portion of the data transfer operation. If the value indicates that an error was not detected, the memory system may determine that the first condition is satisfied. Alternatively, if the value indicates that an error was detected, the memory system may determine that the first condition is not satisfied.

The second condition may include determining whether a duration between the first portion and the second portion of the data transfer operation satisfies a duration threshold. For example, the memory system may identify a second time (e.g., a second timestamp) corresponding to the second portion, and may determine the duration by calculating a difference between the first time and the second time. If the duration is less than the duration threshold, the memory system may determine that the second condition is satisfied. Alternatively, if the duration exceeds the duration threshold, the memory system may determine that the second condition is not satisfied.

The third condition may include determining whether a difference of temperature between the first portion and the second portion satisfies a temperature threshold (e.g., whether a cross-temperature condition exists between the first portion and the second portion). For example, the memory system may measure a second temperature of the source block 205 (e.g., the junction temperature) at or near the second time and may calculate a difference between the first temperature and the second temperature. If the difference is less than the temperature threshold, the memory system may determine that the third condition is satisfied. Alternatively, if the temperature exceeds the temperature threshold, the memory system may determine that the third condition is not satisfied.

In some cases, the first condition, the second condition, the third condition, or a combination thereof may be interdependent. For example, the memory system may select or calculate the temperature threshold using the duration between the first portion and the second portion, such that a relatively short duration may correspond to a larger temperature threshold. Additionally, or alternatively, the memory system may select or calculate the duration threshold using the difference in temperature between the first portion and the second portion, such that a relatively small duration may correspond to a longer duration threshold.

FIG. 2B illustrates the data path 200-b to transfer data from a source block 205 to a destination block 210, for example as part of the second portion of the data transfer operation. The second portion of the operation may include issuing a command to a memory device that includes the source block 205-b (e.g., issuing a command from a memory system controller 115 to a memory device 130). The command may be an example of a copyback command or other command to transfer data to a buffer 215-b. In response to the command, the memory device may retrieve the data from the source block 205-b and store the data to the buffer 215-b. In some examples, the buffer 215-b may be an example of volatile memory, such as a set of one or more data latches, and may be located in or arranged on the memory device (e.g., may be on the same memory die as the source block 205-b).

The data path 200-b may bypass the buffer 220, the encoder 225, or both. For example, if the first condition, the second condition, the third condition, or a combination thereof are satisfied, the memory system may safely perform the second portion of the data transfer operation without applying the one or more error control operations to the data or transferring the data through the buffer 220. Accordingly, after completing the copyback command, the memory system may issue a command to program the data, or a data pattern corresponding to the data, from the buffer 215-b to the destination block 210-b and thus complete the data transfer operation. Because the second portion of the data transfer operation may bypass the buffer 220, system resource use (e.g., space in the buffer 220, bandwidth over the data bus) may be mitigated, which may improve the ability of the memory system to perform other commands (e.g., commands from the host system), which may improve system performance.

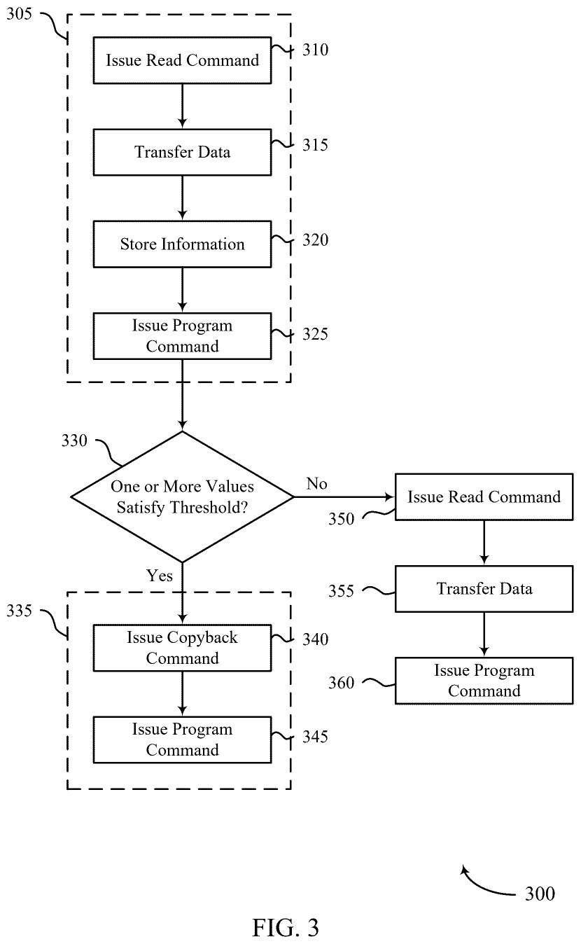

FIG. 3 shows an example of a process flow 300 that supports techniques for improved data folding in accordance with examples as disclosed herein. In some examples, a memory system, which may be an example of the memory system 110 implementing a data path 200-a and a data path 200-b as described with reference to FIGS. 1, 2A, and 2B, may implement aspects of the process flow 300 using a memory system controller (e.g., a memory system controller 115). In the following description of process flow 300, the operations may be performed in a different order than the order shown. For example, specific operations may also be left out of process flow 300, or other operations may be added to process flow 300. Aspects of the process flow 300 may be implemented by one or more controllers, among other components. Additionally, or alternatively, aspects of the process flow 300 may be implemented as instructions stored in one or more memories (e.g., firmware stored in one or more memories, such as a memory device 130 or local memory 120 (or both), coupled with the memory system). For example, the instructions, when executed by one or more controllers (e.g., the memory system controller 115), may cause the one or more controllers (or a device or a system) to perform the operations of the process flow 300.

The process flow 300 may illustrate a data transfer operation to move data from a first block (e.g., the source block 205) to a second block (e.g., the destination block 210). The memory system may perform the data transfer operation over one or more portions, including a first portion 305 and a second portion 335. In some cases, the data transfer operation may be discontinuous. For example, the memory system may execute the first portion 305 at a first time, and, after completing the first portion, may interrupt the data transfer operation to perform one or more commands (e.g., from a host system). The memory system may resume the data transfer operation (e.g., after a delay, after completing the one or more commands) and execute the second portion 335 at a second time.

The first portion 305 may include transferring the data from the first block to the second block via a first data path (e.g., the data path 200-a). For example, at 310, a first command may be issued to a memory device that includes the first block and the second block. In some cases, the memory system may issue the first command to transfer the data to a first buffer (e.g., a buffer 220). The first buffer may be an example of a high-performance buffer, such as an SRAM buffer of a memory controller of the memory system (e.g., local memory 120). In some cases, in response to the first command, the memory device may temporarily store the data at a second buffer, such as a buffer 215.

At 315, the data may be transferred from the memory device (e.g., from the second buffer) to the first buffer. In some cases, as part of transferring the data, the memory system may decode the data, for example using one or more parity bits included in the data. Decoding the data may include performing an error control operation on the data using the bits included in the data, such as by performing an LDPC operation.

At 320, information associated with the first portion 305 may be stored. For example, the memory system may store a first value indicating whether an error was detected in the data (e.g., as part of decoding the data, as part of performing the error control operation), a second value indicating a first time associated with the first portion of the operation, such as a timestamp corresponding to transferring the data to the first buffer, and third value indicating a first temperature associated with the first time, such as a temperature of the first block at the first time.

At 325, a second command may be issued to the memory device. For example, the memory system may issue the second command to program a data pattern associated with the data to the second block. As part of issuing the second command, the memory system may transfer the data from the first buffer to the second buffer on the memory device. Additionally, the memory system may encode the data, such as by using an LDPC operation.

After completing the first portion 305, the memory system may select a data path for the second portion 335. For example, at 330, it may be determined whether one or more conditions are satisfied. For example, the memory system may determine whether a first condition, a second condition, a third condition, or a combination thereof are satisfied. The first condition may include determining whether the first value indicates that that an error was detected in the data. The second condition may include determining whether a difference between the first time and a second time associated with the second portion 335 satisfies a first threshold. The third condition may include determining whether a difference between the first temperature and a second temperature associated with the second time satisfies a second threshold. In some cases, the first condition, the second condition, and the third condition may be interrelated. For example, the memory system may select the first threshold using the difference between the first temperature and the second temperature. Additionally, or alternatively, the memory system may select the second threshold using the difference between the first time and the second time.

If the first condition, the second condition, the third condition, or a combination thereof are satisfied, the memory system may select a second data path (e.g., the data path 200-b) for the second portion 335, and the process flow may proceed to 340. At 340, a third command may be issued. For example, the memory system may issue the third command to transfer the data from the first block to the second buffer. In some cases, the third command may be an example of a copyback command. Subsequently, at 345, a fourth command may be issued. The memory system may issue the fourth command to program a second data pattern associated with the data to the second block. Accordingly, the memory system may perform the second portion 335 without use of the first buffer (e.g., the data may bypass the buffer).

Alternatively, if one or more of the first condition, the second condition, and the third condition are not satisfied, the memory system may select the first data path for the second portion 335 (e.g., the memory system may again use the data path 200-a), and the process flow 300 may proceed to 350. At 350, a fifth command may be issued to the memory device. The memory system may issue the fifth command to transfer the data to the first buffer (e.g., a buffer 220). In some cases, in response to the fifth command, the memory device may temporarily store the data at the second buffer.

At 355, the data may be transferred from the memory device (e.g., from the second buffer) to the first buffer. In some cases, as part of transferring the data, the memory system may decode the data, for example using one or more parity bits included in the data. Decoding the data may include performing an error control operation on the data using the bits included in the data, such as by performing an LDPC operation. At 360, a sixth command may be issued to the memory device. For example, the memory system may issue the sixth command to program a data pattern associated with the data to the second block. As part of issuing the second command, the memory system may transfer the data from the first buffer to the second buffer on the memory device. Additionally, the memory system may encode the data, such as by using an LDPC operation.

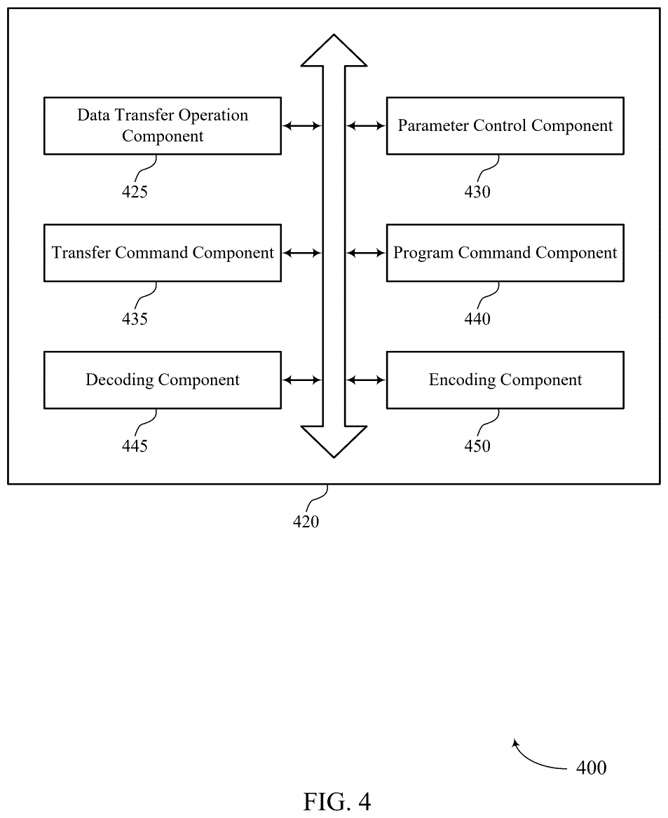

FIG. 4 shows a block diagram 400 of a memory system 420 that supports techniques for improved data folding in accordance with examples as disclosed herein. The memory system 420 may be an example of aspects of a memory system as described with reference to FIGS. 1 through 3. The memory system 420, or various components thereof, may be an example of means for performing various aspects of techniques for improved data folding as described herein. For example, the memory system 420 may include a data transfer operation component 425, a parameter control component 430, a transfer command component 435, a program command component 440, a decoding component 445, an encoding component 450, or any combination thereof. Each of these components, or components of subcomponents thereof (e.g., one or more processors, one or more memories), may communicate, directly or indirectly, with one another (e.g., via one or more buses).

The data transfer operation component 425 may be configured as or otherwise support a means for performing a first portion of an operation, the operation comprising transferring data from a first block of a memory system to a second block of the memory system, the first portion of the operation including transferring the data from the first block to a buffer and transferring the data from the buffer to the second block. The parameter control component 430 may be configured as or otherwise support a means for storing a first value indicating whether an error was detected in the data, a second value indicating a first time associated with the first portion of the operation, and third value indicating a first temperature associated with the first time. In some examples, the data transfer operation component 425 may be configured as or otherwise support a means for performing a second portion of the operation based at least in part on the first value indicating that an error was not detected in the data, on a difference between the first time and a second time associated with the second portion of the program operation satisfying a first threshold, and on a difference between the first temperature and a second temperature associated with the second time satisfying a second threshold, the second portion of the operation including transferring the data from the first block to the second block and bypassing the buffer.

In some examples, the transfer command component 435 may be configured as or otherwise support a means for issuing, to a memory device including the first block and the second block, a first command to transfer the data to the buffer. In some examples, the program command component 440 may be configured as or otherwise support a means for issuing, to the memory device, a second command to program a data pattern associated with the data to the second block, where performing the first portion of the operation is based at least in part on issuing the first command and issuing the second command.

In some examples, the transfer command component 435 may be configured as or otherwise support a means for issuing, to a memory device including the first block and the second block, a first command to transfer the data to a second buffer included in the memory device. In some examples, the program command component 440 may be configured as or otherwise support a means for issuing, to the memory device, a second command to program a data pattern associated with the data to from the second buffer to the second block, where performing the second portion of the operation is based at least in part on issuing the first command and issuing the second command.

In some examples, the first command includes a copyback command.

In some examples, the second buffer includes one or more data latches associated with the first block and the second block.

In some examples, the decoding component 445 may be configured as or otherwise support a means for decoding, as part of transferring the data from the first block to the buffer, the data, where the first value indicating whether the error was detected in the data is based at least in part on the decoding. In some examples, the encoding component 450 may be configured as or otherwise support a means for encoding, as part of transferring the data from the buffer to the second block, the data.

In some examples, the decoding component 445 may be configured as or otherwise support a means for performing an error control operation on the data using one or more parity bits included in the data, where decoding the data includes performing the error control operation.

In some examples, the error control operation includes a low-density parity check (LDCP) operation.

In some examples, the parameter control component 430 may be configured as or otherwise support a means for selecting the first threshold based at least in part on the difference between the first temperature and the second temperature satisfying a third threshold.

In some examples, the data transfer operation component 425 may be configured as or otherwise support a means for performing a first portion of a second operation to transfer second data from the first block to the second block, the first portion of the second operation including transferring the second data from the first block to the buffer and transferring the data from the buffer to the second block. In some examples, the parameter control component 430 may be configured as or otherwise support a means for storing a fourth value indicating whether an error was detected in the second data, a fifth value indicating a third time associated with the first portion of the second operation, and sixth value indicating a third temperature associated with the third time. In some examples, the data transfer operation component 425 may be configured as or otherwise support a means for performing a second portion of the second operation based at least in part on the first value indicating that an error was detected in the data, on a difference between the third time and a fourth time associated with the second portion of the second program operation failing to satisfy a third threshold, or on a difference between the third temperature and a fourth temperature associated with the fourth time failing to satisfy a fourth a threshold, the second portion of the second operation including transferring the second data from the first block to the buffer and transferring the data from the buffer to the second block.

In some examples, the first block is a single-level cell (SLC) block of memory cells, and the second block is a quad-level cell (QLC) block of memory cells.

In some examples, the first block is a triple-level cell (TLC) block of memory cells, and the second block is a quad-level cell (QLC) block of memory cells.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

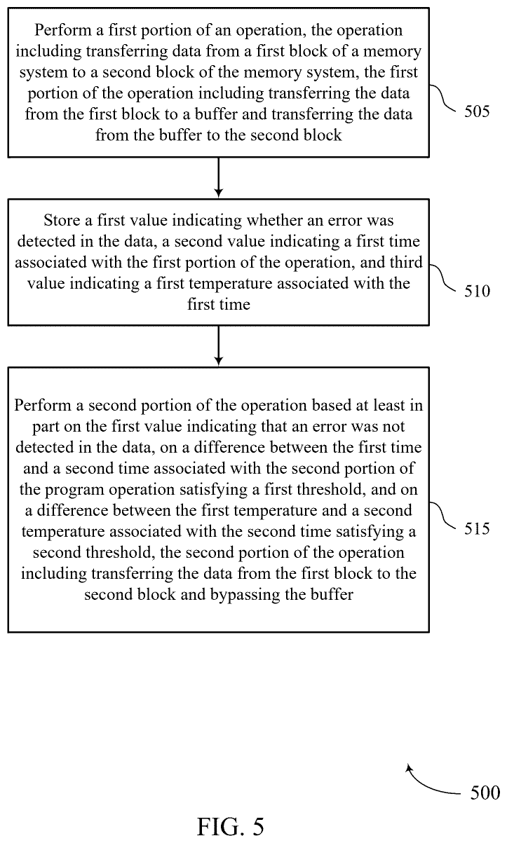

FIG. 5 shows a flowchart illustrating a method 500 that supports techniques for improved data folding in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include performing a first portion of an operation, the operation including transferring data from a first block of a memory system to a second block of the memory system, the first portion of the operation including transferring the data from the first block to a buffer and transferring the data from the buffer to the second block. In some examples, aspects of the operations of 505 may be performed by a data transfer operation component 425 as described with reference to FIG. 4.

At 510, the method may include storing a first value indicating whether an error was detected in the data, a second value indicating a first time associated with the first portion of the operation, and third value indicating a first temperature associated with the first time. In some examples, aspects of the operations of 510 may be performed by a parameter control component 430 as described with reference to FIG. 4.

At 515, the method may include performing a second portion of the operation based at least in part on the first value indicating that an error was not detected in the data, on a difference between the first time and a second time associated with the second portion of the program operation satisfying a first threshold, and on a difference between the first temperature and a second temperature associated with the second time satisfying a second threshold, the second portion of the operation including transferring the data from the first block to the second block and bypassing the buffer. In some examples, aspects of the operations of 515 may be performed by a data transfer operation component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing a first portion of an operation, the operation including transferring data from a first block of a memory system to a second block of the memory system, the first portion of the operation including transferring the data from the first block to a buffer and transferring the data from the buffer to the second block; storing a first value indicating whether an error was detected in the data, a second value indicating a first time associated with the first portion of the operation, and third value indicating a first temperature associated with the first time; and performing a second portion of the operation based at least in part on the first value indicating that an error was not detected in the data, on a difference between the first time and a second time associated with the second portion of the program operation satisfying a first threshold, and on a difference between the first temperature and a second temperature associated with the second time satisfying a second threshold, the second portion of the operation including transferring the data from the first block to the second block and bypassing the buffer.
Aspect 2: The method, apparatus, or non-transitory computer-readable medium of aspect 1, further including operations, features, circuitry, logic, means, or instructions, or any combination thereof for issuing, to a memory device including the first block and the second block, a first command to transfer the data to the buffer and issuing, to the memory device, a second command to program a data pattern associated with the data to the second block, where performing the first portion of the operation is based at least in part on issuing the first command and issuing the second command.
Aspect 3: The method, apparatus, or non-transitory computer-readable medium of any of aspects 1 through 2, further including operations, features, circuitry, logic, means, or instructions, or any combination thereof for issuing, to a memory device including the first block and the second block, a first command to transfer the data to a second buffer included in the memory device and issuing, to the memory device, a second command to program a data pattern associated with the data to from the second buffer to the second block, where performing the second portion of the operation is based at least in part on issuing the first command and issuing the second command.
Aspect 4: The method, apparatus, or non-transitory computer-readable medium of aspect 3, where the first command includes a copyback command.
Aspect 5: The method, apparatus, or non-transitory computer-readable medium of any of aspects 3 through 4, where the second buffer includes one or more data latches associated with the first block and the second block.
Aspect 6: The method, apparatus, or non-transitory computer-readable medium of any of aspects 1 through 5, further including operations, features, circuitry, logic, means, or instructions, or any combination thereof for decoding, as part of transferring the data from the first block to the buffer, the data, where the first value indicating whether the error was detected in the data is based at least in part on the decoding and encoding, as part of transferring the data from the buffer to the second block, the data.
Aspect 7: The method, apparatus, or non-transitory computer-readable medium of aspect 6, further including operations, features, circuitry, logic, means, or instructions, or any combination thereof for performing an error control operation on the data using one or more parity bits included in the data, where decoding the data includes performing the error control operation.
Aspect 8: The method, apparatus, or non-transitory computer-readable medium of aspect 7, where the error control operation includes a low-density parity check (LDCP) operation.
Aspect 9: The method, apparatus, or non-transitory computer-readable medium of any of aspects 1 through 8, further including operations, features, circuitry, logic, means, or instructions, or any combination thereof for selecting the first threshold based at least in part on the difference between the first temperature and the second temperature satisfying a third threshold.
Aspect 10: The method, apparatus, or non-transitory computer-readable medium of any of aspects 1 through 9, further including operations, features, circuitry, logic, means, or instructions, or any combination thereof for performing a first portion of a second operation to transfer second data from the first block to the second block, the first portion of the second operation including transferring the second data from the first block to the buffer and transferring the data from the buffer to the second block; storing a fourth value indicating whether an error was detected in the second data, a fifth value indicating a third time associated with the first portion of the second operation, and sixth value indicating a third temperature associated with the third time; and performing a second portion of the second operation based at least in part on the first value indicating that an error was detected in the data, on a difference between the third time and a fourth time associated with the second portion of the second program operation failing to satisfy a third threshold, or on a difference between the third temperature and a fourth temperature associated with the fourth time failing to satisfy a fourth a threshold, the second portion of the second operation including transferring the second data from the first block to the buffer and transferring the data from the buffer to the second block.
Aspect 11: The method, apparatus, or non-transitory computer-readable medium of any of aspects 1 through 10, where the first block is a single-level cell (SLC) block of memory cells, and the second block is a quad-level cell (QLC) block of memory cells.
Aspect 12: The method, apparatus, or non-transitory computer-readable medium of any of aspects 1 through 11, where the first block is a triple-level cell (TLC) block of memory cells, and the second block is a quad-level cell (QLC) block of memory cells.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
processing circuitry associated with one or more memory devices and configured to cause the memory system to:
perform a first portion of an operation, the operation comprising transferring data from a first block of the memory system to a second block of the memory system, the first portion of the operation comprising transferring the data from the first block to a buffer and transferring the data from the buffer to the second block;
store a first value indicating whether an error was detected in the data, a second value indicating a first time associated with the first portion of the operation, and third value indicating a first temperature associated with the first time; and
perform a second portion of the operation based at least in part on the first value indicating that an error was not detected in the data, on a difference between the first time and a second time associated with the second portion of the operation satisfying a first threshold, and on a difference between the first temperature and a second temperature associated with the second time satisfying a second threshold, the second portion of the operation comprising transferring the data from the first block to the second block and bypassing the buffer.

2. The memory system of claim 1, wherein the processing circuitry is further configured to cause the memory system to:
issue, to a memory device of the one or more memory devices comprising the first block and the second block, a first command to transfer the data to the buffer; and
issue, to the memory device, a second command to program a data pattern associated with the data to the second block, wherein performing the first portion of the operation is based at least in part on issuing the first command and issuing the second command.

3. The memory system of claim 1, wherein the processing circuitry is further configured to cause the memory system to:
issue, to a memory device of the one or more memory devices comprising the first block and the second block, a first command to transfer the data to a second buffer included in the memory device; and
issue, to the memory device, a second command to program a data pattern associated with the data to from the second buffer to the second block, wherein performing the second portion of the operation is based at least in part on issuing the first command and issuing the second command.

4. The memory system of claim 3, wherein the first command comprises a copyback command.

5. The memory system of claim 3, wherein the second buffer comprises one or more data latches associated with the first block and the second block.

6. The memory system of claim 1, wherein the processing circuitry is further configured to cause the memory system to:
decode, as part of transferring the data from the first block to the buffer, the data, wherein the first value indicating whether the error was detected in the data is based at least in part on the decoding; and
encode, as part of transferring the data from the buffer to the second block, the data.

7. The memory system of claim 6, wherein the processing circuitry is further configured to cause the memory system to:
perform an error control operation on the data using one or more parity bits included in the data, wherein decoding the data comprises performing the error control operation.

8. The memory system of claim 7, wherein the error control operation comprises a low-density parity check (LDCP) operation.

9. The memory system of claim 1, wherein the processing circuitry is further configured to cause the memory system to:
select the first threshold based at least in part on the difference between the first temperature and the second temperature satisfying a third threshold.

10. The memory system of claim 1, wherein the processing circuitry is further configured to cause the memory system to:
perform a first portion of a second operation to transfer second data from the first block to the second block, the first portion of the second operation comprising transferring the second data from the first block to the buffer and transferring the data from the buffer to the second block;
store a fourth value indicating whether an error was detected in the second data, a fifth value indicating a third time associated with the first portion of the second operation, and sixth value indicating a third temperature associated with the third time, and
perform a second portion of the second operation based at least in part on the first value indicating that an error was detected in the data, on a difference between the third time and a fourth time associated with the second portion of the second operation failing to satisfy a third threshold, or on a difference between the third temperature and a fourth temperature associated with the fourth time failing to satisfy a fourth a threshold, the second portion of the second operation comprising transferring the second data from the first block to the buffer and transferring the data from the buffer to the second block.

11. The memory system of claim 1, wherein the first block is a single-level cell (SLC) block of memory cells, and the second block is a quad-level cell (QLC) block of memory cells.

12. The memory system of claim 1, wherein the first block is a triple-level cell (TLC) block of memory cells, and the second block is a quad-level cell (QLC) block of memory cells.

13. A non-transitory computer-readable medium storing code comprising instructions which, when executed by one or more processors of a memory system, cause the memory system to:
perform a first portion of an operation, the operation comprising transferring data from a first block of the memory system to a second block of the memory system, the first portion of the operation comprising transferring the data from the first block to a buffer and transferring the data from the buffer to the second block;
store a first value indicating whether an error was detected in the data, a second value indicating a first time associated with the first portion of the operation, and third value indicating a first temperature associated with the first time; and
perform a second portion of the operation based at least in part on the first value indicating that an error was not detected in the data, on a difference between the first time and a second time associated with the second portion of the operation satisfying a first threshold, and on a difference between the first temperature and a second temperature associated with the second time satisfying a second threshold, the second portion of the operation comprising transferring the data from the first block to the second block and bypassing the buffer.

14. The non-transitory computer-readable medium of claim 13, wherein the instructions, when executed by the one or more processors of the memory system, further cause the memory system to:
issue, to a memory device comprising the first block and the second block, a first command to transfer the data to the buffer; and
issue, to the memory device, a second command to program a data pattern associated with the data to the second block, wherein performing the first portion of the operation is based at least in part on issuing the first command and issuing the second command.

15. The non-transitory computer-readable medium of claim 13, wherein the instructions, when executed by the one or more processors of the memory system, further cause the memory system to:
issue, to a memory device comprising the first block and the second block, a first command to transfer the data to a second buffer included in the memory device; and
issue, to the memory device, a second command to program a data pattern associated with the data to from the second buffer to the second block, wherein performing the second portion of the operation is based at least in part on issuing the first command and issuing the second command.

16. The non-transitory computer-readable medium of claim 15, wherein the first command comprises a copyback command.

17. The non-transitory computer-readable medium of claim 15, wherein the second buffer comprises one or more data latches associated with the first block and the second block.

18. The non-transitory computer-readable medium of claim 13, wherein the instructions, when executed by the one or more processors of the memory system, further cause the memory system to:
decode, as part of transferring the data from the first block to the buffer, the data, wherein the first value indicating whether the error was detected in the data is based at least in part on the decoding; and
encode, as part of transferring the data from the buffer to the second block, the data.

19. The non-transitory computer-readable medium of claim 18, wherein the instructions, when executed by the one or more processors of the memory system, further cause the memory system to:
perform an error control operation on the data using one or more parity bits included in the data, wherein decoding the data comprises performing the error control operation.

20. The non-transitory computer-readable medium of claim 19, wherein the error control operation comprises a low-density parity check (LDCP) operation.

21. The non-transitory computer-readable medium of claim 13, wherein the instructions, when executed by the one or more processors of the memory system, further cause the memory system to:
select the first threshold based at least in part on the difference between the first temperature and the second temperature satisfying a third threshold.

22. The non-transitory computer-readable medium of claim 13, wherein the instructions, when executed by the one or more processors of the memory system, further cause the memory system to:
perform a first portion of a second operation to transfer second data from the first block to the second block, the first portion of the second operation comprising transferring the second data from the first block to the buffer and transferring the data from the buffer to the second block;
store a fourth value indicating whether an error was detected in the second data, a fifth value indicating a third time associated with the first portion of the second operation, and sixth value indicating a third temperature associated with the third time, and
perform a second portion of the second operation based at least in part on the first value indicating that an error was detected in the data, on a difference between the third time and a fourth time associated with the second portion of the second operation failing to satisfy a third threshold, or on a difference between the third temperature and a fourth temperature associated with the fourth time failing to satisfy a fourth a threshold, the second portion of the second operation comprising transferring the second data from the first block to the buffer and transferring the data from the buffer to the second block.

23. The non-transitory computer-readable medium of claim 13, wherein the first block is a single-level cell (SLC) block of memory cells, and the second block is a quad-level cell (QLC) block of memory cells.

24. The non-transitory computer-readable medium of claim 13, wherein the first block is a triple-level cell (TLC) block of memory cells, and the second block is a quad-level cell (QLC) block of memory cells.

25. A method, comprising:
performing a first portion of an operation, the operation comprising transferring data from a first block of a memory system to a second block of the memory system, the first portion of the operation comprising transferring the data from the first block to a buffer and transferring the data from the buffer to the second block;
storing a first value indicating whether an error was detected in the data, a second value indicating a first time associated with the first portion of the operation, and third value indicating a first temperature associated with the first time; and
performing a second portion of the operation based at least in part on the first value indicating that an error was not detected in the data, on a difference between the first time and a second time associated with the second portion of the operation satisfying a first threshold, and on a difference between the first temperature and a second temperature associated with the second time satisfying a second threshold, the second portion of the operation comprising transferring the data from the first block to the second block and bypassing the buffer.
